(19) United States
(12) Patent Application Publication
(10) Pub. No.: US 2026/0212849 A1
(43) Pub. Date: Jul. 23, 2026

(54) MUSIC PLAYBACK DEVICE, MUSIC PLAYBACK METHOD, AND PROGRAM

(71) Applicant: AlphaTheta Corporation, Yokohama-shi, Kanagawa (JP)

(72) Inventor: Kenta SAGAWA, Yokohama-shi, Kanagawa (JP)

(21) Appl. No.: 19/141,183

(22) PCT Filed: Dec. 21, 2022
(86) PCT No.: PCT/JP2022/047074

§ 371 Date: Jun. 19, 2025

(51) Int. Cl. G10H 1/00

(52) U.S. Cl. CPC G10H 1/0033; G10H 1/0008; G10H 2210/056; G10H 2250/641

(57) ABSTRACT

Provided is a music playback device including: a music playback section configured to play a music piece, the music piece including a plurality of parts that are acoustically separable from each other; a cue point setting section configured to set, as cue point information, a position of a cue point within the music piece and a part, of the plurality of parts, to be played from the cue point, in response to an operation of a user; a playing position regulating section configured to cause the music piece to be played from the cue point in accordance with the operation of the user and the cue point information; and a playing part regulating section configured to cause only one or more, but not all, of the plurality of parts to be played when the music piece is played from the cue point, in accordance with the cue point information.

### TECHNICAL FIELD

The present invention relates to a music playback device, a music playback method, and a program.

### BACKGROUND ART

For example, in a DJ device, a playback start position is designated within a music piece, and playback of the music piece is started from the designated playback start position when a predetermined operation is performed. The playback start position to be designated is also referred to as a cue point. A technique for playback of a music piece using such a cue point is described in Patent Literature 1, for example.

Another technique has been known in which a music piece is acoustically separated into multiple parts and a service is provided by using audio data of the separated parts. For example, Patent Literature 2 discloses a technique of arranging a piece of predetermined part data of multiple pieces of part data separated by a music separating means to create a piece of arranged part data, and transmitting the piece of arranged part data, and a piece or pieces of original part data in which the piece of predetermined part data is removed from the multiple pieces of part data.

### CITATION LIST

### Patent Literature(s)

Patent Literature 1: Japanese U.S. Pat. No. 6,263,417
Patent Literature 2: JP 2009-186729 A

### SUMMARY OF THE INVENTION

### Problem(s) to be Solved by the Invention

However, the two techniques described above, i.e., the technique for playback of a music piece using a cue point, and the technique using audio data of separated parts of a music piece, have not been combined. Accordingly, when, for example, a player wants to start playback of only a specific part of a music piece from a designated position, such playback itself is possible; however, an operation is complicated and difficult to execute the operation in real-time DJ play.

An object of the invention is thus to provide a music playback device, a music playback method, and a program each of which enables easy execution of playback using audio data of separated parts of a music piece when playing the music piece using a cue point.

### Means for Solving The Problem(s)

[1] A music playback device including: a music playback section configured to play a music piece, the music piece including a plurality of parts that are acoustically separable from each other; a cue point setting section configured to record, as cue point information, a position of a cue point within the music piece and at least one part, of the plurality of parts, to be played from the cue point, in response to an operation of a user; a playing position regulating section configured to cause the music piece to be played from the cue point in accordance with the operation of the user and the cue point information; and a playing part regulating section configured to cause only one or more, but not all, of the plurality of parts to be played when the music piece is played from the cue point, in accordance with the cue point information.
[2] The music playback device according to [1], in which the plurality of parts include three or more parts, and the cue point setting section is configured to record, as the cue point information, two or more parts as parts to be played from the cue point.
[3] The music playback device according to [1] or [2], in which the cue point setting section is configured to set the position of the cue point and then set the at least one part to be played from the cue point.
[4] The music playback device according to [1] or [2], in which the cue point setting section is configured to set the at least one part to be played from the cue point and then set the position of the cue point.
[5] A music playback method including: playing a music piece, the music piece including a plurality of parts that are acoustically separable from each other; recording, as cue point information, a position of a cue point within the music piece and at least one part, of the plurality of parts, to be played from the cue point, in response to an operation of a user; and causing the music piece to be played from the cue point and causing only one or more, but not all, of the plurality of parts to be played when the music piece is played from the cue point, in accordance with the operation of the user and the cue point information.
[6] A program causing a computer to function as a music playback device, the music playback device including: a music playback section configured to play a music piece, the music piece including a plurality of parts that are acoustically separable from each other; a cue point setting section configured to record, as cue point information, a position of a cue point within the music piece and at least one part, of the plurality of parts, to be played from the cue point, in response to an operation of a user; a playing position regulating section configured to cause the music piece to be played from the cue point in accordance with the operation of the user and the cue point information; and a playing part regulating section configured to cause only one or more, but not all, of the plurality of parts to be played when the music piece is played from the cue point, in accordance with the cue point information.

### BRIEF DESCRIPTION OF DRAWINGS

FIG. 1 is a diagram illustrating an overall configuration of a system according to one exemplary embodiment of the invention.

FIG. 2 is a block diagram illustrating a configuration of functions included in a music playback device illustrated in FIG. 1.

FIG. 3 is a diagram illustrating an example of a cue point setting screen according to the exemplary embodiment of the invention.

FIG. 4 is a flowchart illustrating an example of a process of cue point setting in the music playback device according to the exemplary embodiment of the invention.

FIG. 5 is a flowchart illustrating an example of a process of playing a music piece from the cue point in the music playback device according to the exemplary embodiment of the invention.

### DESCRIPTION OF EMBODIMENT(S)

The following describes preferred exemplary embodiments of the invention in detail with reference to the accompanying drawings. Note that, in this description and the accompanying drawings, components that have substantially the same functional configuration are indicated by the same codes, and thus redundant description thereof is omitted.

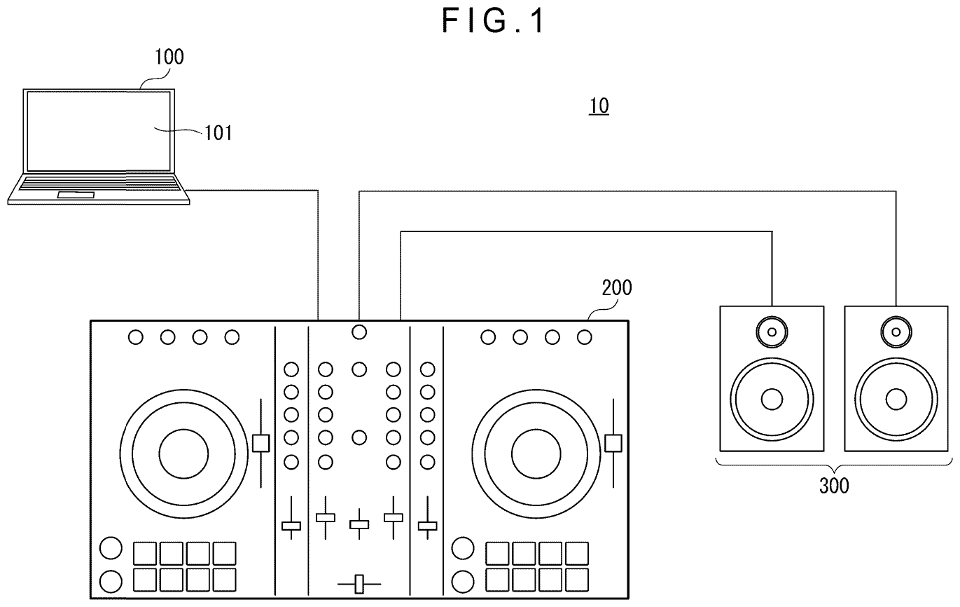

FIG. 1 is a diagram illustrating an overall configuration of a system according to an exemplary embodiment of the invention. A system 10 according to the exemplary embodiment includes a PC (Personal Computer) 100, a DJ controller 200, and a speaker 300. The PC 100 is a device that stores, processes, and plays audio data. The PC 100 is not limited to a PC, and may be a terminal device such as a tablet or a smartphone. The PC 100 includes a display 101 that displays information to a user, and an input device such as a touch panel or a mouse that acquires an operation input of the user. The DJ controller 200 is coupled to the PC 100, for example, via a communication means such as a USB (Universal Serial Bus), and acquires the user's operation input related to playback of a music piece by a channel fader, a cross fader, a performance pad, a jog dial, various knobs and/or buttons, or the like. The audio data is played by, for example, the speaker 300.

In the exemplary embodiment, the PC 100 functions as a music playback device in the above-described system 10. In this case, the PC 100 executes a process of the music playback device to be described below in response to the user's operation input acquired through the input device such as a touch panel or a mouse, or through the DJ controller 200. In the exemplary embodiment, the PC 100 functions as the music playback device; however, in another exemplary embodiment, a DJ device such as a mixer or an all-in-one DJ system (a digital audio player having communication and mixing functions) may function as the music playback device. Further, a server coupled to a PC or a DJ device via a network may also function as the music playback device.

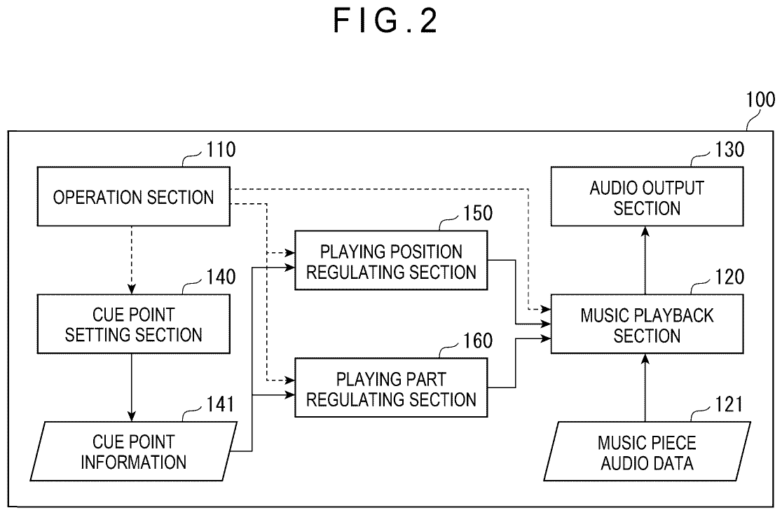

FIG. 2 is a block diagram illustrating a configuration of functions included in the music playback device illustrated in FIG. 1. In the illustrated example, the PC 100 includes an operation section 110, a music playback section 120, an audio output section 130, a cue point setting section 140, a playing position regulating section 150, and a playing part regulating section 160. In the following, further description is given of the above sections. The operation section 110 is implemented by an interface that receives an operation signal from the input device such as a touch panel or a mouse of the PC 100, or from the DJ controller 200. The music playback section 120, the audio output section 130, the cue point setting section 140, the playing position regulating section 150, and the playing part regulating section 160 are implemented by a CPU (Central Processing Unit) or a DSP (Digital Signal Processor) that operates in accordance with a program stored in a memory or a storage. Hereinafter, the functions of the sections will be further described.

The music playback section 120 plays a music piece in accordance with an operation of a user. More specifically, the music playback section 120 controls the audio output section 130 in accordance with, for example, music piece audio data 121 stored in the PC 100 or acquired from an external device such as a server and the operation of the user acquired by the operation section 110, and causes the speaker 300 to output a sound of the music piece. The audio output section 130 is, for example, a driver of the speaker 300 coupled to the PC 100 via the DJ controller 200, and causes the speaker 300 to output the sound in accordance with control of the music playback section 120. In the exemplary embodiment, it is possible for the music playback section 120 to play the music piece in parallel with use of two decks of the DJ controller 200. For example, it is possible to play different music pieces on the two decks and cross-fade them, or while continuing playing a music piece on one deck, to play the same music piece on the other deck with use of headphones or the like that only the user (a DJ) can listen to and to perform an operation of setting a cue point.

In the exemplary embodiment, the music piece audio data 121 includes the music piece including multiple parts that are acoustically separable from each other. The multiple parts that are acoustically separable from each other include a vocal part, an instrument sound part, etc., which are separable within the music piece based on, for example, a frequency band. For example, one instrument sound may be separated into multiple parts, e.g., a drum sound may be separated into parts of a bass drum, a hi-hat, and a snare. The music piece audio data 121 may include audio data of multiple parts separated using, for example, a known music piece separation engine, or may include audio data of multiple parts recorded for each part from the beginning. Alternatively, as the music piece audio data 121, audio data of multiple parts of a music piece being played in real time may be input.

The cue point setting section 140 records, as cue point information 141, a position of a cue point within the music piece and a part to be played from the cue point among the multiple parts of the music piece. The position of the cue point and the part to be played are set in response to the operation of the user acquired by the operation section 110. The cue point is recorded for playing the music piece from a specific position within the music piece in response to the operation of the user. The position of the cue point within the music piece is recorded with use of a time stamp, for example. The part to be played from the cue point is set using, for example, an ID that is given to each of the multiple parts of the music piece audio data 121. Thus, for example, cue point information such as “play only vocal from 1 minute 12 seconds (chorus)”, “play only drum from 0 seconds (intro)”, or “play only non-base from 3 minutes 12 seconds (outro)” is set. Note that it is not necessarily only one or more, but not all, of the parts of the music piece that are instructed to be played by the cue point information 141, and all of the parts of the music piece may be instructed to be played by at least a part of the cue point information.

Here, the cue point setting section 140 may set multiple kinds of cue points that differ in a manner of recording and a behavior with respect to a user's operation. Specifically, for example, a hot cue and a memory cue may be set. The hot cue is recorded by being allocated to a cue button to be described later, where the user's operation immediately starts playback from the cue point. The memory cue is recorded by being automatically sorted in a chronological order, where the user's operation causes a playback standby mode once and then the next operation starts playback from the cue point.

In the exemplary embodiment, the cue point setting section 140 sets the cue point in response to an operation performed on the operation section 110 by the user who is simultaneously listening to the sound of the music piece being output by the music playback section 120 and the audio output section 130, for example. Either the position of the cue point or the part to be played may be set first. Specifically, the user may perform an operation of setting the position of the cue point and then perform an operation of selecting the part to be played from the set cue point, or may first perform the operation of selecting the part to be played and then perform the operation of setting the position of the cue point. Further, the cue point setting section 140 may set the part to be played from the cue point and record the cue point information 141 first, and then may update the cue point information 141 in accordance with the operation of the user to change the part to be played from the cue point.

The playing position regulating section 150 causes the music piece to be played from the cue point within the music piece in accordance with the operation of the user acquired by the operation section 110 and the cue point information 141. Here, the cue point information 141 may be set by the cue point setting section 140 of the PC 100, or may be set by an external device and transmitted to the PC 100. Specifically, the playing position regulating section 150 controls the music playback section 120 so that the playback of the music piece is started from a playing position indicated by the cue point information 141 at a timing designated by the operation of the user.

The playing part regulating section 160 causes only one or more, but not all, of the multiple parts of the music piece to be played when the music piece is played from the cue point, in accordance with the operation of the user acquired by the operation section 110 and the cue point information 141. Specifically, the playing part regulating section 160 controls the music playback section 120 to play only one or more, but not all, of the multiple parts of the music piece by activating one or more, but not all, of pieces of audio data of the multiple parts included in the music piece audio data 121 and deactivating the rest. Thus, when the playback of the music piece is started from the cue point, for example, the music piece that has been played by all of the parts is played by only one or more, but not all, of the parts, or the music piece that has been played by a certain part is played by another part. Alternatively or additionally, when the playback of the music piece is started from the cue point, the playing part regulating section 160 may be capable of causing the music piece that has been played by only one or more, but not all, of the parts to be played by all of the parts.

The number of the multiple parts included in the music piece is not particularly limited. For example, when the music piece includes two parts, the cue point setting section 140 sets one of the two parts as the part to be played from the cue point. Further, when the music piece includes three or more parts, the cue point setting section 140 may set only one part as the part to be played from the cue point, or may set two or more parts as the parts to be played from the cue point.

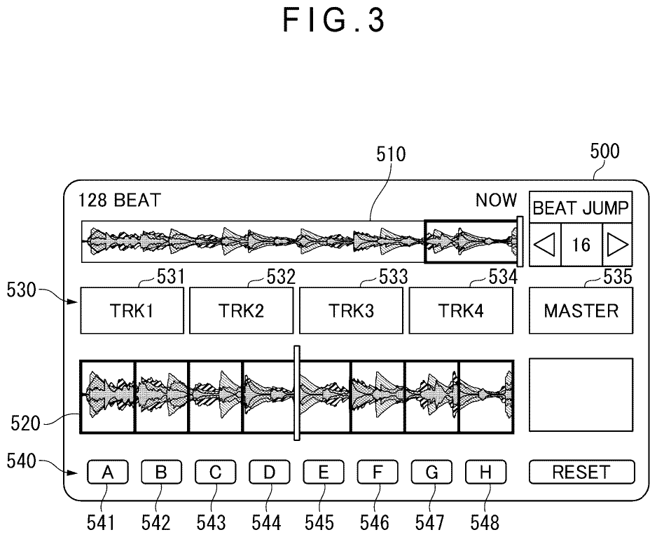

FIG. 3 is a diagram illustrating an example of a cue point setting screen according to the exemplary embodiment of the invention. In the illustrated example, a screen 500 is displayed as a GUI (Graphical User Interface) on the display 101 of the PC 100 illustrated in FIG. 1. The screen 500 includes a waveform of playing music 510, a waveform for editing 520, a truck selection button 530, and a cue point allocation button 540. The waveform of playing music 510 displays a waveform of the music piece being played by the music playback section 120. The waveform for editing 520 displays a waveform of the music piece to be used to set the cue point by the cue point setting section 140. For example, the user sets a cue point from which a part selected by the truck selection button 530 is to be played from positions within the music piece indicated by a playback head of the waveform for editing, and allocates the cue point to the cue point allocation button 540.

In the illustrated example, the truck selection button 530 includes buttons 531 to 534 for selecting one or more parts from among up to four parts included in the music piece and a button 535 for selecting all of the parts. The cue point allocation button 540 includes buttons 541 to 548 to which up to eight cue points can be allocated. Note that since it is already known that the selection of the part of the music piece and the setting of the playing position of the music piece with use of the cue point are performed individually, various known GUIs are usable for the selection and setting without being limited to the illustrated example.

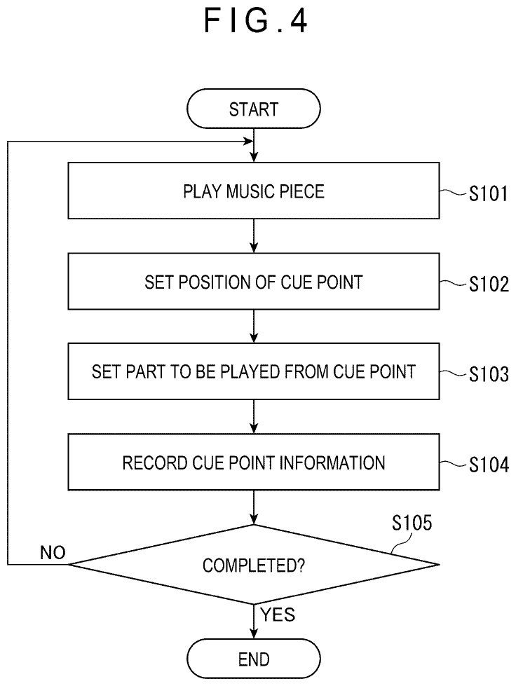

FIG. 4 is a flowchart illustrating an example of a process of cue point setting in the music playback device according to the exemplary embodiment of the invention. In the illustrated example, when the music playback section 120 is playing the music piece (Step S101), an operation of setting the cue point is executed. Specifically, in response to the operation of the user acquired by the operation section 110, the cue point setting section 140 sets the position of the cue point (Step S102), and sets the part to be played from the cue point (Step S103). Note that Steps S102 and S103 may be executed substantially simultaneously or may be executed with a time difference, and either Step S102 or Step S103 may be executed first. The cue point setting section 140 records the cue point information 141 including information on the position of the cue point and the part to be played that have been set (Step S104). The above-described process may be repeated until the user performs an operation to complete the process (Step S105), and for example, multiple cue points may be set in one music piece. Although not illustrated, a procedure of user's trial listening may be executed by playing the music piece from the playing position by the part, the playing position and the part having been set prior to recording the cue point information.

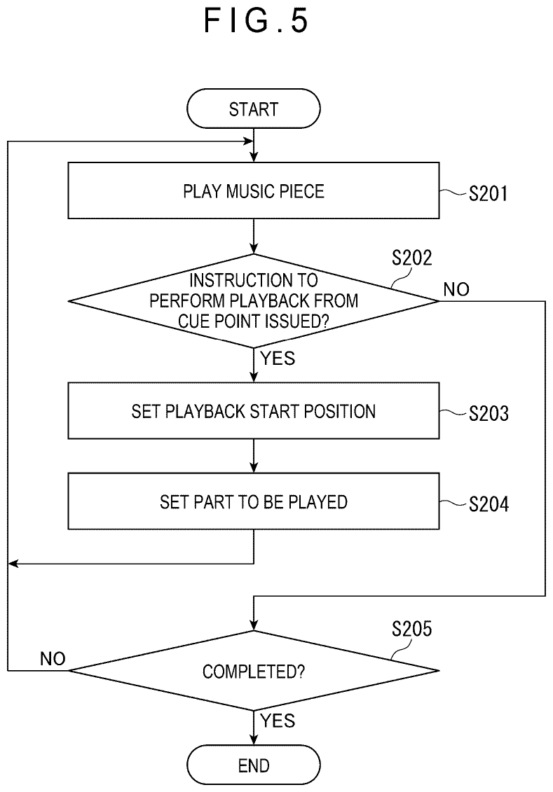

FIG. 5 is a flowchart illustrating an example of a process of playing the music piece from the cue point in the music playback device according to the exemplary embodiment of the invention. In the illustrated example, when the music playback section 120 is playing the music piece (Step S201), an instruction to play the music piece from the cue point is issued in response to the operation of the user acquired by the operation section 110 (Step S202). In this case, in accordance with designated cue point information 141, the playing position regulating section 150 sets the playback start position of the music piece (Step S203), the playing part regulating section 160 sets the part of the music piece to be played (Step S204), and the music piece is played from the set position by the set part (Step S201). Note that, as long as Steps S203 and S204 are completed before the playback of the music piece from the cue point is executed, either Step S203 or Step S204 may be executed first, or Steps S203 and S204 may be executed substantially simultaneously. If any instruction of playback from the cue point is not issued, playback of the music piece is continued as is until the end (Step S205). Although not illustrated, in addition to Steps S202 to S204, the user may be capable of performing an operation of playing the music piece from the cue point without changing the playing part, and an operation of changing the part to be played without changing the playing position.

According to the exemplary embodiment of the invention as described above, when the music piece is played using the cue point, it is possible to easily execute the playback using the audio data of the separated parts of the music piece. The operation of selecting the part of the music piece to be played and the operation of playing the music piece from the cue point have been separately set in typical techniques, in which although it has been possible to perform in advance the operation of setting the cue point, it has not been possible to set in advance which part is to be played from the cue point. Accordingly, the user has had to perform an operation of playing the music piece from the cue point and at the same time separately perform an operation of changing a part to be played. Thus, in addition to the operations being complicated and not easy to execute during a real-time performance, it has been also inconvenient for the user to have to remember which part the user wants to play for each cue point. In the exemplary embodiment of the invention as described above, recorded as the cue point information is information on not only the position of the cue point within the music piece but also on the part to be played from the cue point. When the cue point is set, it is thus possible to play the part intended by the user in real time during a performance.

### Explanation of Codes

10: system, 100: PC, 101: display, 110: operation section, 120: music playback section, 121: music piece audio data, 130: audio output section, 140: cue point setting section, 141: cue point information, 150: playing position regulating section, 160: playing part regulating section, 200: DJ controller, 300: speaker, 500: screen, 510: waveform of playing music, 520: waveform for editing, 530: truck selection button, 540: cue point allocation button.

1. A music playback device comprising:
a music playback section configured to play a music piece, the music piece including a plurality of parts that are acoustically separable from each other;
a cue point setting section configured to record, as cue point information, a position of a cue point within the music piece and at least one part, of the plurality of parts, to be played from the cue point, the position of the cue point and the at least one part to be played being set in response to an operation of a user;
a playing position regulating section configured to cause the music piece to be played from the cue point in accordance with the operation of the user and the cue point information; and
a playing part regulating section configured to cause only one or more, but not all, of the plurality of parts to be played when the music piece is played from the cue point, in accordance with the cue point information.

2. The music playback device according to claim 1, wherein
the plurality of parts include three or more parts, and
the cue point setting section is configured to record, as the cue point information, two or more parts as parts to be played from the cue point.

3. The music playback device according to claim 1, wherein the cue point setting section is configured to set the position of the cue point and then set the at least one part to be played from the cue point.

4. The music playback device according to claim 1, wherein the cue point setting section is configured to set the at least one part to be played from the cue point and then set the position of the cue point.

5. A music playback method comprising:
playing a music piece, the music piece including a plurality of parts that are acoustically separable from each other;
recording, as cue point information, a position of a cue point within the music piece and at least one part, of the plurality of parts, to be played from the cue point, the position of the cue point and the at least one part to be played being set in response to an operation of a user; and
causing the music piece to be played from the cue point and causing only one or more, but not all, of the plurality of parts to be played when the music piece is played from the cue point, in accordance with the operation of the user and the cue point information.

6. A non-transitory tangible storage medium storing a program causing a computer to function as a music playback device, the music playback device comprising:
a music playback section configured to play a music piece, the music piece including a plurality of parts that are acoustically separable from each other;
a cue point setting section configured to record, as cue point information, a position of a cue point within the music piece and at least one part, of the plurality of parts, to be played from the cue point, the position of the cue point and the at least one part to be played being set in response to an operation of a user;
a playing position regulating section configured to cause the music piece to be played from the cue point in accordance with the operation of the user and the cue point information; and
a playing part regulating section configured to cause only one or more, but not all, of the plurality of parts to be played when the music piece is played from the cue point, in accordance with the cue point information.
